(19) United States
(12) Patent Application Publication
(10) Pub. No.: US 2012/0191284 A1
(43) Pub. Date: Jul. 26, 2012

(54) Method for Pulling a Vehicle Out of a Parking Space With Assistance, and Device for that Purpose

(76) Inventors: Meike Fehse, Rutesheim (DE); Marcus Schneider, Ludwigsburg (DE); Thomas Scheuerle, Murr (DE)

(21) Appl. No.: 13/388,847

(22) PCT Filed: Aug. 3, 2010
(86) PCT No.: PCT/EP2010/061321

§ 371 Date: Apr. 13, 2012

(30) Foreign Application Priority Data
Aug. 6, 2009 (DE) 102009028309

(51) Int. Cl. G05D 1/02

(52) U.S. Cl. 701/23

(57) ABSTRACT

In a method for pulling a vehicle out of a parking space with assistance by a parking-assistance device, at least one pulling-out movement is performed by intervention in a steering system of the vehicle. A warning is output to a driver of the vehicle when the driver of the vehicle fails to take over the guidance of the vehicle after the assistance by the parking-assistance device in pulling out of the parking space has ended.

### BACKGROUND OF THE INVENTION

1. Field of the Invention

The present invention relates to a method for pulling a vehicle out of a parking space with assistance by a parking-assistance device, by which at least one pull-out motion is executed by intervention in a steering system of the vehicle.

2. Description of Related Art

Methods for pulling a vehicle out of a parking space with assistance by parking-assistance devices are familiar, a controlled intervention in a steering system of the vehicle releasing the driver from the operation of the steering wheel, so that he only has to operate the accelerator and the brake pedal. Using such parking-assistance devices, the driver is able to both pull the vehicle into a parking space and pull the vehicle out of the parking space. In so doing, the steering system receives steering commands from the parking-assistance device; the steering system may be in the form of an EPS system, what is referred to as an Electric Power Steering System. These electrically operated steering systems have an electric actuator such as an electric motor which actively guides the steering system of the vehicle, as is also possible by manual operation of the steering wheel.

The German Patent application 10 2007 029 773 A1 describes a parking-assistance device to implement a method for pulling a vehicle out of a parking space with assistance. In that case, the parking-assistance device interacts with a steering system that has an actuator which is able to adjust a steering angle in the steerable wheels of the vehicle. This actuator may be an element of the steering system that is used, for example, to support a steering motion of the steering wheel, as is already familiar from a power steering system. In the process, the actuator of the steering system may be controlled by the parking-assistance device. For this, it is provided that the support of the steering system by the parking-assistance device may be terminated at any time by the driver of the vehicle. For example, it is proposed that the parking-assistance device have the ability to be deactivated by way of a control panel, via which an activating action is also detectable. Furthermore, the action by the parking-assistance device may be terminated by a reset of the turn-indicator function or the exceeding of a threshold speed. In addition, it may be provided to deactivate the parking-assistance device when the driver intervenes actively in the steering. The deactivation of the parking-assistance device involves ending the assistance by the parking-assistance device in leaving a parking space.

The German Patent application 10 2004 055 584 A1 describes a method for the assisted parking of a vehicle in a parking space. In that case, the parking-assistance device checks whether a torque applied by the driver against an artificial steering stop exceeds a defined threshold value. So long as the driver introduces a steering torque above the threshold value into the steering wheel, the parking operation may be continued. As soon as the steering torque applied by the driver becomes too weak, the parking operation is stopped or discontinued by a brake intervention. Therefore, a safety measure is implemented to ensure that the driver continues to attend to the process of parking the vehicle. The printed publication cited describes exclusively the parking of a vehicle in a parking space with the aid of a parking-assistance device. Dangers which are associated with pulling the vehicle out of the parking space and therefore entering into the road traffic are neither dealt with nor resolved in the publication cited.

What are termed self-steering parking-assistance devices which intervene directly in the steering system of the vehicle and assist the driver in maneuvering the vehicle out of the parking space, must signal to the driver when the assistance by the parking-assistance device in leaving the parking space is terminated. After the assistance has ended, the driver must ultimately take over complete control of the vehicle again in order, for example, to get the vehicle into the flowing road traffic.

If the self-steering parking-assistance device detects that it is possible to pull out into the traffic without a collision with the objects bordering the parking space, the driver is informed of this and the assistance by the parking-assistance device in pulling out of the parking space is terminated. After that, the driver must take over the guidance of the vehicle.

However, if the driver does not take notice of the deactivation information for terminating the support by the parking-assistance device in pulling out of the parking space, or does not realize that although he is able to leave the parking space, he himself must also take over the steering of the vehicle, then dangerous situations may result. Since the steering system is now no longer retained actively at a specific steering angle, the steering usually relaxes, and in doing so, its alignment during the subsequent maneuvering changes. Because of this, the direction of travel changes, which may lead to a collision with the objects bordering the parking space. Moreover, a source of danger lies in the fact that the driver can believe that the parking-assistance device would turn his vehicle into the road traffic, and as a result, the driver accelerates the vehicle. Because of the indefinite steering angle, this will lead with a certain probability to a turn into the lane of oncoming traffic. Until the driver recognizes his mistake, a collision with other road users may come about until the driver has guided his vehicle out of the danger zone again.

Therefore, the object of the present invention is to overcome the disadvantages of the related art indicated above, and to provide a method for pulling a vehicle out of a parking space with assistance by a parking-assistance device, the method making it possible to pull the vehicle out of a parking space with greater safety. It is further the object of the present invention to provide a parking-assistance device that makes it possible to pull a vehicle out of a parking space with improved safety.

This objective is achieved starting from a method according to the preamble of Claim 1 and a parking-assistance device according to the preamble of Claim 12, having the respective characterizing features. Advantageous further refinements of the present invention are specified in the dependent claims.

The present invention includes the technical teaching that a warning is output to the driver of the vehicle when the vehicle driver fails to take over the guidance of the vehicle after the assistance by the parking-assistance device in pulling out of the parking space has ended.

In this context, the invention starts from the idea that a warning is provided by the parking-assistance device to the driver of the vehicle when the vehicle driver does not take over the guidance of the vehicle in time to avert a dangerous situation. It may thereby be ensured that the driver does not mistakenly depend on the parking-assistance device to continue to guide the vehicle, and even that the parking-assistance device would slip the vehicle into the flowing traffic.

Preferably, the parking-assistance device determines an assistance end position at which the guidance of the vehicle by the parking-assistance device is terminated. The attainment of the assistance end position is indicated to the driver of the vehicle. Consequently, according to the present invention, the warning is output to the driver of the vehicle only when the assistance end position was already reached, and the fact that it was reached was also indicated to the driver, but the driver has not yet taken over the guidance of the vehicle, even after the assistance end position was reached.

It has proven to be advantageous if the parking-assistance device determines a distance which the vehicle travels after reaching the assistance end position. Consequently, the warning is only output to the driver of the vehicle when the vehicle has traveled the distance after reaching or exceeding the assistance end position, and when the driver has still not taken over the guidance of the vehicle, at least up to the moment the distance is reached. At the end of the maneuver of pulling out from the parking space and after it has been output to the driver that the assistance end position has been reached, the parking-assistance device expects that the driver will take charge of the guidance of the vehicle.

However, if the driver fails to take over the guidance of the vehicle, the dangerous situation arises, namely, that the driver will rely on further guidance of the vehicle by the parking-assistance device. Therefore, an uncontrolled guidance of the vehicle results, so that after distance S has been exceeded, a suitable measure is introduced which brings the driver, for example, to stop the vehicle. Consequently, the warning may be a parking-assist stop warning, which is output to the driver of the vehicle.

In order to recognize whether the driver has assumed or failed to assume the guidance of the vehicle after the assistance end position, various possibilities are given for detecting this information and transmitting it to the parking-assistance device. In principle, all technical means are conceivable, which detect the takeover of the guidance of the vehicle by the driver or the failure of the driver to assume the guidance of the vehicle.

For example, a steering-torque sensor device may be provided by which the parking-assistance device recognizes the takeover of the guidance of the vehicle by the driver when the driver manually introduces a torque into the vehicle steering system via a steering wheel. Such a steering-torque sensor device may already be a component of conventional EPS steering systems, a steering torque being measured by a steering-torque sensor device in order to determine the direction and the level of steering assistance, and to provide the servo assistance accordingly, e.g., by an electric actuator.

Furthermore, the possibility exists that a steering-wheel sensor device is provided with whose aid the parking-assistance device recognizes a manual operation of the steering wheel. This “hands-on” detection makes it possible to detect the hands of the driver on the steering wheel, in order to provide information to the parking-assistance device as to whether or not the driver is already embracing the steering wheel in his hands. For example, a steering-wheel sensor device may take the form of a capacitive or inductive sensor device, an electrode being inserted in the rim of the steering wheel, so that a change in the capacitive coupling between the electrode and the surroundings of the electrode, owing to the embrace of the steering-wheel rim in the hands is detected by the steering-wheel sensor device and signaled to the parking-assistance device.

According to one advantageous specific embodiment of the present invention, the parking-assistance device may output the warning to the driver acoustically, e.g., via at least one loudspeaker, visually, e.g., via a display device and/or via haptically acting means. In this context, the display device may correspond to an indicator unit as is also used for parking-aid devices such as Park Distance Control Systems, which inform the driver visually about objects in the vicinity of the vehicle. For instance, the indicator unit may be a display in the instrument panel of the vehicle, or the indicator unit may be in the form of a head-up display in order to image the information in the windshield of the vehicle. If the warning is output to the driver via haptically acting means, a vibration may be introduced into the steering wheel, into the driver's seat or into the pedals of the vehicle, for example, so that the driver perceives the indication as a warning in order to take over the guidance of the vehicle immediately. In particular, the warning may include a stop prompt, which is perceived by the driver as a signal of an immediately imminent danger.

Moreover, the warning may be reset completely by the parking-assistance device when the driver of the vehicle performs a defined action. For example, the defined action may include taking charge of the steering wheel, stopping the vehicle to a standstill, actuating a push-button switch or engaging the reverse gear. In addition, the defined action may also involve a combination of the actions indicated. For instance, by actuating a push-button switch, the driver may confirm to the parking-assistance device that he is taking over the guidance of the vehicle, so that the understanding of the driver that at this point, he himself must take charge of the guidance of the vehicle is communicated to the parking-assistance device.

Naturally, the warning is not output to the driver when he has already taken charge of the steering wheel within the distance.

According to a further advantageous specific embodiment, the parking-assistance device may call for an active steering intervention by the driver. This may be accomplished in that the parking-assistance device applies a torque to the steering, which means the series hands-on detection of the EPS system may be used. In this context, it may be provided that at the end of the pulling-out maneuver, the parking-assistance device signals to the driver that at this point, the driver should take charge of the steering wheel. Furthermore, after the last actively steered pulling-out maneuver of the parking-assistance device, the steering-wheel angle is set so that after the hand-over to the driver, the steering is not in the neutral position, but rather has an angle differing from the straight-ahead position. For instance, this may be a steering-wheel angle of 180°. Consequently, in order to pull out of the parking space, the driver must simply hold on to the steering wheel, thus, take over the steering. Since the steering-wheel angle is selected in such a way that the resulting pulling-out curve leads past the parking-space boundaries, the vehicle can only be moved out of the parking space without collision when the steering wheel is controlled by the driver.

However, after the driver has received the prompt to take over the steering, the active steering intervention by the parking-assistance device is not deactivated; rather, a steering movement is actively requested, which for the driver, appears like the relaxing of the steering after deactivation of the steering intervention, that manifests itself in a slight turning-back of the steering wheel by, for instance, 10° in the direction toward the neutral position, with subsequent post-oscillation by a few degrees in both directions. This movement of the steering wheel, actually automatically associated kinematically with the rolling of the vehicle, is introduced artificially into the steering by the EPS system.

If the driver now takes charge of the steering wheel, e.g., he takes firm hold of the steering wheel, then this will lead automatically to an opposite torque counter to the active steering movement requested. The EPS system will detect this with an integrated hands-on detection, which, for instance, is made possible by the steering-wheel sensor device. Consequently, upon detection of the take-over of the steering wheel, the parking-assistance device terminates the active steering intervention. The ascertained assumption of the steering wheel by the driver may be communicated to the parking-assistance device by a CAN bus system. As soon as the parking-assistance device has received the information, it will terminate the EPS support of the steering, that is, the driver is now able to continue without the occurrence of a stop warning by the parking-assistance device. However, if the parking-assistance device does not receive this information before a maximum permissible distance traveled is reached, a stop warning is then output.

The present invention is further directed to a parking-assistance device for pulling a vehicle out of a parking space with assistance, by which at least one pulling-out movement is executable by intervention in a steering system of the vehicle, the parking-assistance device being designed to output a warning to a driver of the vehicle, the warning being able to be output when the driver of the vehicle fails to take over the guidance of the vehicle after the assistance by the parking-assistance device in pulling the vehicle out of the parking space has ended.

### BRIEF DESCRIPTION OF THE DRAWINGS

FIG. 1 shows a situation of a vehicle pulling out of a parking space, in the top sub-figure, the vehicle initially executing a first pulling-out movement, and in the bottom sub-figure, a distance being entered, after which, a warning is output to a driver of the vehicle.

FIG. 2 shows a schematic view of a steering wheel, having a steering-torque sensor device and a steering-wheel sensor device.

FIG. 3 shows a steering angle/time diagram for a maneuver for pulling a vehicle out of a parking space.

### DETAILED DESCRIPTION OF THE INVENTION

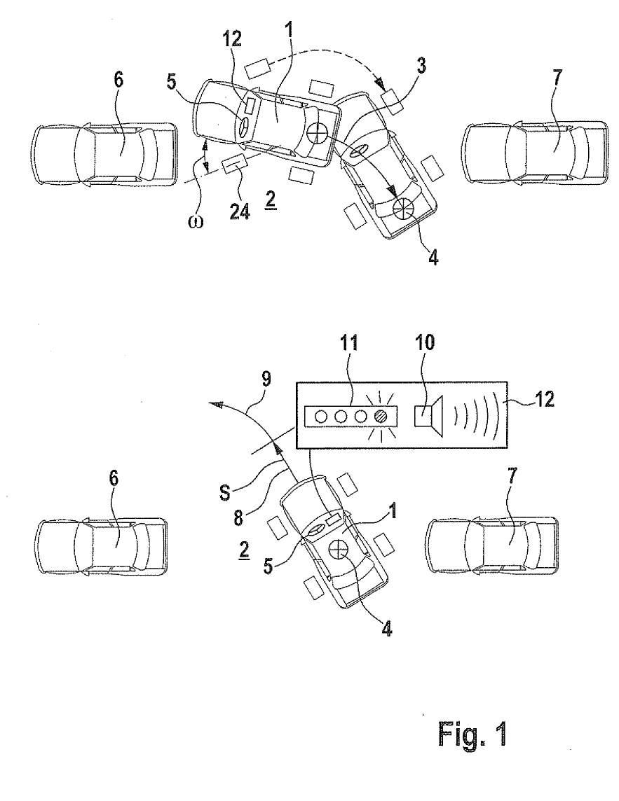

FIG. 1 shows a steering-assisted pulling-out maneuver, which is executable with a method according to the present invention for pulling vehicle 1 out of parking space 2 with assistance by a parking-assistance device. A vehicle 1 is shown, which is parked between two objects 6 and 7, objects 6 and 7 corresponding to further vehicles 6 and 7. Parking space 2 is a parallel parking space, from which vehicle 1 is to be pulled out. The top sub-figure initially shows vehicle 1 between vehicles 6 and 7 in two positions, namely, in a first position, from which vehicle 1 performs a pulling-out movement 3 that corresponds to a reverse movement of vehicle 1. In the bottom sub-figure, vehicle 1 is shown again in the position which corresponds to the upper view after first pulling-out movement 3 has ended.

In this context, vehicle 1 backs up along pulling-out movement 3 shown, until the parking-assistance device, with the aid of an indicator unit 12, signals the driver that he must now take over steering 5 of vehicle 1, since he can now easily drive in the forward direction out of parking space 2.

During pulling-out movement 3 executed in reverse, steering 5 is controlled actively by the parking-assistance device, that is, steering angle co of wheels 24 of vehicle 1 is set in such a way that during next following forward movement 8 and 9, it is possible to drive out of the parking space. After reaching point 4, which represents assistance end position 4, the guidance of vehicle 1 by the parking-assistance device is terminated.

The driver will now engage the forward gear and begin to drive out of parking space 2. However, if during the forward driving in first segment 8 of the forward movement, the driver has not taken charge of the steering by the time distance S shown is reached, that is, if the driver has not grasped steering wheel 5 of vehicle 1, a warning is then output by indicator unit 12 to the driver. In so doing, for example, the warning may be output via at least one loudspeaker 10 or a display device 11, in order to convey the warning acoustically or visually to the driver. In addition, the warning may be output to the driver by haptically acting means, for instance, by introducing a vibration into steering wheel 5 or the driver's seat of vehicle 1, or, for example, into the pedals of vehicle 1, as well.

In particular, indicator unit 12, which is represented only schematically in the figure, may be the same device which is also used as a parking aid to inform the driver whether there is an obstacle in the area of the bumper of vehicle 1, and how far the vehicle is from this obstacle. During the process of pulling out, the driver thereby also reacts intuitively with an immediate stopping of vehicle 1 for the case when he has not taken over steering 5 and is warned by the pulling-out aid system.

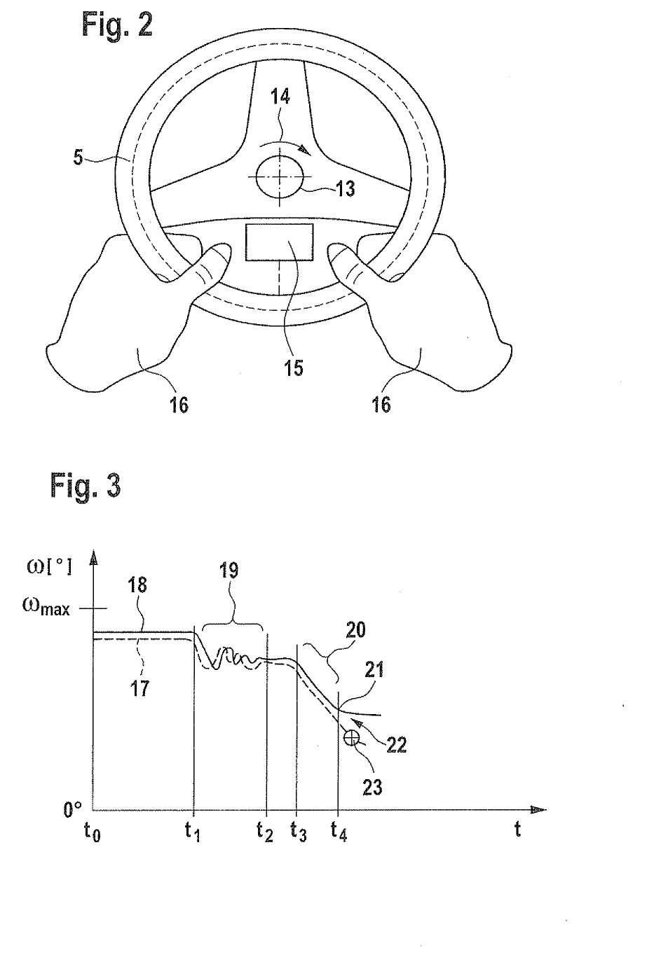

FIG. 2 shows the view of a steering wheel 5 in a schematic representation. Steering wheel 5 has a steering-torque sensor device 13, which is indicated schematically in the hub of steering wheel 5. Steering-torque sensor device 13 is used to measure a steering torque 14 which can be introduced into steering wheel 5 by the driver via hands 16. Steering-torque sensor device 13 may be a component of the EPS system and is not as a general principle disposed in steering wheel 5, but rather in the steering gear between steering wheel 5 and pivoted wheels 24 of vehicle 1.

A steering-wheel sensor device 15 is also shown, which is disposed in the rim of steering wheel 5. Steering-wheel sensor device 15 may be implemented as a capacitively acting sensor device in order to detect the embrace of steering wheel 5 by hands 16 of the driver. Such sensor systems act capacitively or inductively, in the case of capacitively acting sensor devices, the capacitive coupling between an electrode and the surroundings, which is changed by an embrace of the rim of steering wheel 5 by hands 16, being measured.

As soon as the driver takes over steering 5 with his hands 16 and effectuates a slight steering-wheel motion, a steering torque 14 is obtained, which is detected by steering-torque sensor device 13. Thus, the parking-assistance device recognizes that the guidance of vehicle 1 has been taken over, because the steering intervention thus detected is conveyed to the parking-assistance device.

FIG. 3 shows in a diagram the characteristic of steering angle ω over time t. In the diagram, an exemplary embodiment of the present invention is represented, in which an active steering intervention by the driver is called for by the parking-assistance device. Initially, the steering intervention is activated by the parking-assistance device. The steering intervention by an active control of steering 5 is able to be recognized by the driver. Broken line 17 represents angle request ω of the parking-assistance device to the EPS system over time t. Solid line 18 indicates actual steering angle ω. After the last reverse movement, which corresponds to pulling-out movement 3 in FIG. 1 and takes place in the period of time t₀ to t₁, the steering is retained at a constant value. After the driver has been informed that he must take over the steering, a termination of the steering intervention is simulated vis-à-vis the driver by a seeming relaxing of the steering; this phase corresponds to section 19 which represents steering-relaxation phase 19.

During this relaxation process, the parking-assistance device controls the steering in such a way that steering angle ω is reduced within a short time and then the oscillation of steering wheel 5 subsides; this corresponds to the time from t₁ to t₂.

If the driver now moves vehicle 1, a reducing steering-angle phase 20 is then requested, which for the driver, appears as if the steering would relax further owing to the vehicle movement. In this context, it should be noted that in response to a movement of a vehicle, without steering intervention, the steering moves slowly toward a neutral position, which corresponds to the straight-ahead driving of a vehicle.

If, during the rolling process, the driver now takes hold of steering wheel 5 at instant t4, he will automatically generate a counter-torque, since due to steering-angle request 17, the EPS system, even after instant t4, will still try for a brief time to turn the steering with the aid of the electric actuator of the EPS system. As a result, a measurable torque is thus obtained in the steering linkage, and also an increasing angle difference between the steering-wheel angle requested and the actual steering-wheel angle, which corresponds to a difference between steering-angle request 17 and actual steering angle 18 after the point of the steering angle in start-to-roll phase 21. This difference is indicated as steering-angle difference 22.

This difference is recognized by the EPS control internally as hands-on detection, so that the driver must keep hands 16 on steering wheel 5, since otherwise, the torque cannot be introduced into the steering. As a result, the switch-on of the activation of the steering by the EPS system is terminated, so that an assistance end point 23 is reached. Consequently, starting immediately, no more steering requests are accepted from outside, and the parking-assistance device is informed by the EPS system that the driver has taken charge of the steering. Therefore, a warning is effectively prevented from being output to the driver, even though he is already operating steering 5 with his hands 16. In addition, the advantage is achieved that this function is very transparent for the driver, i.e., he does not have to execute any steering motion in order to recognize his take-over of vehicle 1 from the parking-assistance device.

The present invention is not limited in its implementation to the preferred exemplary embodiment indicated above. Rather, a number of variants are conceivable which make use of the design approach presented, even in the case of fundamentally different implementations. All features and/or advantages, including structural particulars, spatial arrangements and method steps, derived from the claims, the description or the drawing can be essential to the invention, both alone and in greatly differing combinations.

1-12. (canceled)

13. An automated method for guiding a vehicle out of a parking space with assistance of a parking-assistance device, comprising:
automatically guiding, with assistance of the parking-assistance device, a pull-out movement of the vehicle from the parking space by intervention in a steering system of the vehicle; and
outputting a warning to a driver of the vehicle when the driver of the vehicle fails to take over the guidance of the vehicle after termination of the automatically guided pull-out movement of the vehicle from the parking space.

14. The method as recited in claim 13, further comprising:
determining by the parking-assistance device an assistance end position at which the automatically guided pull-out movement of the vehicle from the parking space is terminated.

15. The method as recited in claim 14, further comprising:
providing an indication to the driver of the vehicle the reaching of the assistance end position by the vehicle.

16. The method as recited in claim 14, further comprising:
determining by the parking-assistance device a distance traveled by the vehicle after reaching the assistance end position.

17. The method as recited in claim 16, wherein the warning is output to the driver of the vehicle when the vehicle has traveled a predefined threshold distance after reaching the assistance end position and the driver has failed to take over the guidance of the vehicle.

18. The method as recited in claim 14, wherein a steering-torque sensor device provides an indication to the parking-assistance device regarding the takeover of the guidance of the vehicle by the driver of the vehicle when the driver manually introduces a torque via a steering wheel into the steering system of the vehicle.

19. The method as recited in claim 18, wherein a steering-wheel sensor device provides an indication to the parking-assistance device regarding a manual operation of the steering wheel.

20. The method as recited in claim 18, wherein the warning is output to the driver by the parking-assistance device at least one of (i) acoustically via a loudspeaker, (ii) visually via a display device, and (iii) haptically via a haptic indicator.

21. The method as recited in claim 20, wherein the warning is terminated by the parking-assistance device when the driver of the vehicle performs a predefined action.

22. The method as recited in claim 21, wherein the predefined action is an active steering intervention by the driver.

23. The method as recited in claim 18, wherein, when a steering intervention carried out by the driver is detected by the parking-assistance device, the parking-assistance device terminates the automatic guidance of the vehicle.

24. A parking-assistance device for automatically guiding a pull-out movement of a vehicle from a parking space, comprising:
a control unit for automatically guiding the pull-out movement of the vehicle from the parking space by intervention in a steering system of the vehicle; and
a warning unit for outputting a warning to a driver of the vehicle when the driver of the vehicle fails to take over the guidance of the vehicle after termination of the automatically guided pull-out movement of the vehicle from the parking space.
